(19) United States
(12) Patent Application Publication
(10) Pub. No.: US 2023/0415226 A1
(43) Pub. Date: Dec. 28, 2023

(54) 3D PRINTER FILAMENT COMPOSITION CONTAINING METAL POWDER, AND FILAMENT USING SAME

(71) Applicant: KOLON PLASTICS, INC., Gimcheon (KR)

(72) Inventors: Jong Hoe OH, Gimcheon (KR); Doo Sik MIN, Gimcheon (KR)

(21) Appl. No.: 18/250,552

(22) PCT Filed: Oct. 26, 2021
(86) PCT No.: PCT/KR2021/015140

§ 371 Date: Apr. 26, 2023

(30) Foreign Application Priority Data
Oct. 27, 2020 (KR) 10-2020-0140394

(51) Int. Cl. B22F 1/103; C09D 123/00; C09D 159/02; C09D 7/65; C09D 7/63; C09D 7/61; B33Y 70/10; B22F 3/20; B22F 3/10; B22F 3/24; B22F 10/64; B22F 10/62; B33Y 40/20; B22F 5/12

(52) U.S. Cl. CPC B22F 1/103; B22F 2201/11; C09D 159/02; C09D 7/65; C09D 7/63; C09D 7/61; B33Y 70/10; B22F 3/20; B22F 3/1025; B22F 3/24; B22F 10/64; B22F 10/62; B33Y 40/20; B22F 5/12; B22F 2998/10; B22F 2003/248; B22F 2999/00; B22F 2201/20; C09D 123/00

(57) ABSTRACT

The present invention provides a 3D printer composition, a 3D printer filament using same, and a method for manufacturing a metal steel product by using the filament, the composition including: 10 wt % to 30 wt % of a polymer binder including 3.5 wt % to 10 wt % of polyacetal, 3.5 wt % to 10 wt % of a polyolefin elastomer, 2 wt % to 6 wt % of a plasticizer, and 1 wt % to 4 wt % of a lubricant; and 70 wt % to 90 wt % of a metal powder.

### TECHNICAL FIELD

The present invention relates to a 3D printer filament composition containing a metal powder and a filament using the same. More particularly, the present invention relates to a 3D printer composition containing a high content of metal powder and a filament using the same.

### BACKGROUND ART

A 3D (3-Dimensional, three dimensional) printer is a device that produces a real three-dimensional shape based on an input three-dimensional drawing just like printing a letter or a picture. Recently, 3D printing technology has become quite a hot issue and now is spreading to automobile, medical, art, and education fields and is widely being used for making various models.

The most popular 3D printer in the 3D printer market is an extrusion-type 3D printer, which is also called an FDM (Fused deposition modeling)-type printer. Most of materials used in the FDM-type printer are generally plastics such as PLA, PC, ABS, and the like and thus may not be used for manufacturing high-strength parts but are mainly used for manufacturing educational or prototype products.

In order to solve this problem, several companies or research institutes have developed technology to print a material containing metal powder and finally produce a metal output. Korean Patent Registration No. 1761649 discloses a three-dimensional printing composition containing a metal powder, for example, 90.0 wt % to 94.0 wt % of austenitic stainless steel metal powder, 3.0 wt % to 5.0 wt % of a polyethylene binder, 2.5 wt % to 3.5 wt % of a paraffin wax plasticizer, and 0.5 wt % to 1.5 wt % of a stearic acid lubricant.

However, this patent still has a problem of not making a plastic material containing a high content of metal powder into a filament form but using it in a chip or granule type and in addition, producing even the chip or granule type by necessarily using a 3D printer equipped with an extrusion cartridge.

Conventionally, in order to make the plastic material containing metal powder into the filament form, an additional process of coating the surface of a filament through double extrusion is required, resulting in increasing a unit price of the filament or bringing about a problem in quality control.

### DISCLOSURE

### Description of the Drawings

### Technical Problem

Accordingly, the present invention is to provide a 3D printer filament composition which may be manufactured into a filament, even though a high content of metal powder is included therein, by applying a polyolefin elastomer (POE) thereto.

In addition, the present invention is to provide a 3D printer filament produced by extruding the 3D printer filament composition.

Furthermore, the present invention is, when the 3D printer filament is used to adjust degreasing conditions and sintering conditions, since produced through a general extrusion type of 3D printer but wound on a bobbin without problems (neither broken nor cut off), to provide a method of manufacturing metal steel products that are not broken in an extruder (a method of pushing in the form of a gearwheel) at a nozzle part.

### Technical Solution

A 3D printer filament composition containing a metal powder according to the present invention includes: 10 wt % to 30 wt % of a polymer binder including 3.5 wt % to 10 wt % of polyacetal, 3.5 wt % to 10 wt % of a polyolefin elastomer, 2 wt % to 6 wt % of a plasticizer, and 1 wt % to 4 wt % of a lubricant; and 70 wt % to 90 wt % of a metal powder.

The polyacetal may be an oxymethylene homopolymer containing an oxymethylene —(OCH₂)ₙ— group as a repeating unit and capped at both ends by an ester or ether group.

In addition, the polyacetal may be a polyacetal copolymer or terpolymer in which oxyalkylene units having 2 to 10 carbon atoms are randomly inserted in a polymer chain composed of oxymethylene monomer units, and both ends of the polymer are blocked by ester or ether groups.

The polyolefin elastomer may be a polymer resin in the form of a linear, branched, grafted, or composite type composed of 2 to 12 carbon atoms.

The metal powder may include stainless, titanium, a nickel alloy, an amorphous alloy, or a mixture thereof.

The plasticizer may include paraffin wax, carnauba wax, microcrystalline wax, beeswax, montan wax, or a mixture thereof.

The lubricant may include stearic acid, Zn-stearate, Ca-stearate, ethylene bis steramide (EBS), or a mixture thereof.

In addition, the present invention provides a filament for a 3D printer manufactured by extruding the 3D printer filament composition containing a metal powder.

The 3D printer filament may have a diameter of 1.5 mm to 3.0 mm.

In addition, the present invention provides a method of manufacturing a metal steel product which includes melting the 3D printer filament to form a semi-finished product in which print layers are continuously laminated in a three-dimensional shape of an object to be printed, degreasing for 6 to 10 hours at 110 to 120° C. and 98% or more nitric acid in order to remove the polymeric binder component from the semi-finished product, sintering at a high temperature of 1350 to 1380° C. to prepare a metal sintered body, and cooling the metal sintered body to room temperature.

### Advantageous Effects

The present invention may provide a filament including a high content of metal powder but needing no additional process of coating the surface and the like and thus still having flexibility, so that it may be wound on a cylindrical bobbin having an interior diameter of 45 mm or more under a normal pressure and optimize degreasing conditions and sintering conditions to effectively manufacture a metal steel product through a generally widely used extrusion 3D printer (FDM method).

### MODE FOR INVENTION

Hereinafter, the present invention will be described in detail.

The present invention provides a 3D printer filament composition containing a metal powder, a filament extruded using the same, and a method for manufacturing a metal steel product using the filament.

The 3D printer filament composition containing a metal powder according to the present invention includes: 10 to 30 wt % of a polymer binder including 3.5 to 10 wt % of polyacetal, 3.5 to 10 wt % of a polyolefin elastomer, 2 to 6 wt % of a plasticizer, and 1 to 4 wt % of a lubricant; and 70 to 90 wt % of a metal powder.

The polyacetal is included at 3.5 to 10 wt % in the total composition, and if the polyacetal is less than 3.5 wt %, there is a risk of damage to the output before the sintering process after degreasing, and if it exceeds 10 wt %, flexibility of the filament may be lowered so that the filament may be broken or disconnected when wound on the bobbin, a time in the degreasing process may be prolonged, or it may be damaged during sintering.

In addition, the polyolefin elastomer is included at 3.5 to 10 wt % in the total composition, and if the content is less than 3.5 wt %, the filament becomes hard and thus cannot be wound on the bobbin, and when it exceeds 10 wt %, it cannot be extruded by the printer's nozzle.

In the present invention, the plasticizer is for facilitating molding during 3D printing, and may include paraffin wax, carnauba wax, microcrystalline wax, bees wax, montan wax, fatty acid wax, natural wax, or a mixture thereof, but is not limited thereto.

A content of the plasticizer may be 2 to 6 wt % in the total composition. If the content of the plasticizer is less than 2 wt %, flowability during filament production may be lowered, making filament production difficult, and if it exceeds 6 wt %, flowability during filament production may increase, making filament production difficult.

The lubricant is for facilitating molding during 3D printing, and examples thereof may include stearic acid, palmitic acid, butyric acid, lauric acid, linoleic acid, oleic acid, ricinoleic acid, and myristic acid, but are not limited thereto.

A content of the lubricant may be 1 to 4 wt % in the total composition. If the content of the lubricant is less than 1 wt %, an interaction between the metal powder and the polymer binder may not be uniformly dispersed due to poor interaction, and if it exceeds 4 wt %, flowability may increase during filament production, making filament production difficult, and output may be damaged during degreasing.

In addition, the composition according to the present invention may include 70 to 90 wt % of stainless, titanium, nickel alloy, amorphous alloy, or a mixture thereof as metal powder in the total composition.

When the content of the metal powder is less than 70 wt %, a final output, which is used to perform degreasing and sintering, may take a longer time for the degreasing due to an excessive amount of the polymer binder and also, may be deformed and cracked during the degreasing and sintering process, and when the content of the metal powder is greater than 90 wt %, even though the polymer binder having flexible characteristics for preparing a filament is included, a bonding force between the metal and the polymer binder may be so much reduced and broken so as to not wound on a bobbin,

In the present invention, the metal powder may be kneaded with polyacetal, polyolefin elastomer, a plasticizer, and a lubricant in a blending machine such as a single screw extruder, a twin-screw extruder, roll-mills, a kneader, a Banbury mixer, or the like to prepare a 3D print filament composition containing metal powder.

In addition, the 3D printer composition containing metal powder may be used through a one-step process or a two-step process to prepare the 3D printer filament of the present invention. The one-step process is to prepare the 3D printer filament by (1) simultaneously performing kneading by using a blending machine such as a single screw extruder, a twin-screw extruder, roll-mills, a kneader, a Banbury mixer, and the like and extruding by using a single screw extruder, and the two-step process is to prepare the 3D printer filament by (1) performing the kneading by using a blending machine such as a single screw extruder, a twin-screw extruder, roll-mills, a kneader, a Banbury mixer, and the like and then pulverizing or pelletizing and then (2) extruding again by using a single screw extruder.

The manufactured 3D printer filament according to the present invention may have a diameter of 1.5 mm to 3.0 mm.

When the filament has a diameter of less than 1.5 mm, the diameter is so small so as to maximize the flexible characteristics so that the filament may not be put into a nozzle during the 3D printing, but if the filament diameter is greater than about 3.0 mm, the filament may not be all melted in the 3D printer nozzle in a short time and thus cause difficulty in print.

The 3D printer filament according to the present invention includes a high content of metal powder but has flexibility and thus may be wound on a cylindrical bobbin with an interior diameter of 45 mm and manufactured into actually used metal parts through a generally widely used extrusion type of 3D printer (FDM method).

The 3D printer filament of the present invention is melted in a printer nozzle and discharged onto the plate surface of the 3D printer to continuously laminate print layers into a three-dimensional shape of an object to be printed, forming a semi-finished product. Subsequently, after removing the solvent and the polymeric binder component in a hot degreasing method, the molded semi-finished product may be sintered at a high temperature and then cooled to room temperature, manufacturing a final steel product, which is a sintered product with high density.

That is, in the present invention, a method of manufacturing a metal steel product includes melting the 3D printer filament to form a semi-finished product in which print layers are continuously laminated in a three-dimensional shape of an object to be printed, degreasing for 6 to 10 hours at 110 to 120° C. and 98% or more nitric acid in order to remove the polymeric binder component from the semi-finished product, sintering at a high temperature of 1350 to 1380° C. to prepare a metal sintered body, and cooling the metal sintered body to room temperature.

During the process, in the degreasing step for removing the polymeric binder component from the semi-finished product, polyacetal may not be smoothly decomposed by nitric acid at less than 110° C., but at greater than 120° C., the polyacetal may be significantly rapidly decomposed by the nitric acid, and accordingly, the degreasing should be performed for 6 hours to 10 hours under 98% or more of the nitric acid in terms of the degreasing and sintering process.

In addition, the sintering temperature may be made at a high temperature of 1350 to 1380° C., and when the sintering temperature is out of the above range, unsintering or oversintering may occur.

In the present invention, a filament for a 3D printer was manufactured by extruding the composition, and then the filament was wound on a bobbin, and the filament was used to output the 3D printer as sculptures and specimens. As a result, it was confirmed that the manufactured filament was wound on the bobbin without interruption, had excellent degreasing characteristics, sintering characteristics, and bed adhesion of specimens, and edge shrinkage of the sculptures, and that 3D printing proceeded smoothly without nozzle clogging.

### DETAILED DESCRIPTION OF THE EMBODIMENTS

### Examples

Hereinafter, the present invention will be described in more detail through examples. These examples are only for illustrating the present invention, and it will be apparent to those skilled in the art that the scope of the present invention is not to be construed as being limited by these examples.

### Examples and Comparative Examples: Preparation of 3D Printer Filament Composition and Filament

Each composition containing the metal powder, polyacetal, polyolefin elastomer, plasticizer (paraffin wax), and lubricant (stearic acid) of Table 1 was prepared.

Each prepared composition was kneaded and extruded by using a single screw extruder (a screw diameter: 30 mm) and then cooled and wound in a cooling water bath, preparing a 3D printer filament with a length of 3 m and a diameter of 1.75 mm.

TABLE 1

| | Examples | | | Comparative Examples | | | | | | | |
|---|---|---|---|---|---|---|---|---|---|---|---|
| | 1 | 2 | 3 | 1 | 2 | 3 | 4 | 5 | 6 | 7 | 8 |
| A | 90 | 85 | 70 | 65 | 92 | 80 | 85 | 85 | 85 | 85 | 85 |
| B | 3.5 | 5.5 | 10 | 12.5 | 2.5 | 5 | 7 | 11 | 0 | 5.5 | 5.5 |
| C | 3.5 | 5.5 | 10 | 12.5 | 2.5 | 5 | 7 | 0 | 11 | 5.5 | 5.5 |
| D | 2 | 3 | 6 | 6 | 2 | 10 | 0 | 3 | 3 | 3 | 3 |
| E | 1 | 1 | 4 | 4 | 1 | 0 | 1 | 1 | 1 | 1 | 1 |

A: Metal powder (Apson Atmix SUS316L PF-15F)
B: Polyacetal copolymer (Kolon Plastic K300)
C: polyolefin elastomer (LG Chem LC180)
D: plasticizer (Seiro paraffin wax)
E: lubricant (LG Chem stearic acid)

### Experimental Example 1: Evaluation of Characteristics of 3D Printer Filament

The manufactured filaments were evaluated with respect to characteristics by winding each filament on a cylinder with a diameter of 45 mm at room temperature under a normal pressure to check whether or not they would be broken, wherein when neither broken nor cut, it was evaluated as good, but when broken or cut, it was evaluated as inferior, and the results are shown in Table 2.

### Experimental Example 2: Evaluation of Characteristics of 3D Sculptures Using 3D Printer Filaments

The 3D printer filaments according to the examples and the comparative examples were used in a 3D printer (ALMOND, OpenCreators) to print out a sculpture (width: 50 mm, length: 50 mm, height: 20 mm) and then evaluated with respect to properties, and the results are shown in Table 2. The sculpture was printed by setting a printing speed: 10 mm/s to 100 mm/s, a nozzle temperature: 170° C. to 220° C., a nozzle diameter: 0.4 mm to 0.6 mm, a bed temperature: 0° C. to 60° C., and internal filling: 100%.

The sculpture was put in a dedicated degreasing furnace and degreased for 6 to 10 hours in total including cooling time at 120° C. to check whether or not a shape thereof was deformed, wherein when there was a crack, it was evaluated as inferior, but when there was no crack, it was evaluated as good. In the examples, the degreasing was performed at 120° C. under nitric acid of 98% or more for 8 hours.

A sculpture of Comparative Example 7 was manufactured by performing the degreasing at 100° C. or less under nitric acid of 98% or more for 6 hours to hours, the sintering at a high temperature of 1350° C. to 1380° C., and the cooling to room temperature.

A sculpture of Comparative Example 8 was manufactured by performing the degreasing at 130° C. or higher under nitric acid of 98% or more for 6 to 10 hours, the sintering at a high temperature of 1350° C. to 1380° C., and the cooling to room temperature.

Sintering characteristics were evaluated by heating the sculptures to 1000° C. under a vacuum atmosphere and to 1350° C. under an argon gas atmosphere, and then cooling them by checking whether or not there was a crack, wherein when there was a crack, it was evaluated as inferior but when there was no change, it was evaluated as good.

Bed adhesion was evaluated by checking whether or not the sculptures were well adhered to a floor but did not fall off during the 3D printing, wherein when well adhered, it was evaluated as good, but when it fell off or was deformed, it was evaluated as inferior.

3D printing characteristics were evaluated as inferior when the sculptures were excited at the edges after the printing or when the nozzle was clogged during the printing but as good when the printing smoothly proceeded.

TABLE 2

| | Examples | | | Comparative Examples | | | | | | | |
|---|---|---|---|---|---|---|---|---|---|---|---|
| | 1 | 2 | 3 | 1 | 2 | 3 | 4 | 5 | 6 | 7 | 8 |
| Filament | Good | Good | Good | Good | Inferior | Good | Good | Inferior | Inferior | Good | Good |
| characteristics | | | | | | | | | | | |
| Degreasing | Good | Good | Good | Inferior | — | Inferior | Inferior | — | — | Inferior | Inferior |
| characteristics | | | | | | | | | | | |
| Sintering | Good | Good | Good | Inferior | — | Inferior | Inferior | — | — | Inferior | Inferior |
| characteristics | | | | | | | | | | | |
| Bed | Good | Good | Good | Inferior | — | Inferior | Inferior | — | — | Good | Good |
| adhesion | | | | | | | | | | | |
| Printing | Good | Good | Good | Inferior | — | Inferior | Good | — | — | Good | Good |
| characteristics | | | | | | | | | | | |

Referring to Table 2, the filaments according to the examples of the present invention turned out to be not broken when wound on a cylinder with a diameter of 45 mm, but the filaments of the comparative examples exhibited slightly deteriorated properties when out of the composition range of the present invention.

In addition, when comparing properties of the 3D sculptures manufactured by using the 3D printer filaments, the 3D sculptures manufactured by using the filaments of the examples of the present invention exhibited excellent properties through degreasing, sintering, bed adhesion, and printing characteristics.

However, in the case of the 3D sculptures using the filaments manufactured according to the comparative examples, overall properties of the degreasing, the sintering, the bed adhesion, and the printing characteristics were deteriorated.

In particular, as for Comparative Examples 2, 5, and 6 using metal powder or polyacetal and polyolefin elastomer out of the content ranges of the present invention, since a filament itself was impossible to manufacture, properties such as degreasing, sintering, bed adhesion, printing characteristics, and the like were impossible to measure.

In addition, Comparative Examples 7 and 8, in which the degreasing and sintering processes were different from those of the present invention, turned out to exhibit inferior degreasing and sintering characteristics.

As above, a specific part of the contents of the present invention has been described in detail, and for a person of ordinary skill in the art, this specific description is only a preferred embodiment, and thereby the scope of the present invention is not limited. Accordingly, the substantial scope of the present invention will be defined by the appended claims and their equivalents.

### INDUSTRIAL APPLICABILITY

The present invention relates to a 3D printer composition containing metal powder and a filament using the same, wherein the filament is flexible and thus wound on a cylindrical bobbin with an interior diameter 45 mm or more without being broken at room temperature under a normal pressure to optimize degreasing conditions and sintering conditions, effectively manufacturing a metal steel product through a generally widely used extrusion 3D printer (FDM method).

1. A 3D printer filament composition containing a metal powder, comprising:
10 wt % to 30 wt % of a polymer binder including 3.5 wt % to 10 wt % of polyacetal, 3.5 wt % to 10 wt % of a polyolefin elastomer, 2 wt % to 6 wt % of a plasticizer, and 1 wt % to 4 wt % of a lubricant; and
wt % to 90 wt % of a metal powder.

2. The 3D printer filament composition of claim 1, wherein
the polyacetal is an oxymethylene homopolymer containing an oxymethylene —(OCH₂)ₙ— group as a repeating unit and capped at both ends by an ester or ether group, or a polyacetal copolymer or terpolymer in which oxyalkylene units having 2 to 10 carbon atoms are randomly inserted in a polymer chain composed of oxymethylene monomer units, and both ends of the polymer are blocked by ester or ether groups.

3. The 3D printer filament composition of claim 1, wherein
the polyolefin elastomer is a polymer resin in the form of a linear, branched, grafted, or composite type composed of 2 to 12 carbon atoms.

4. The 3D printer filament composition of claim 1, wherein
the metal powder includes stainless, titanium, a nickel alloy, an amorphous alloy, or a mixture thereof.

5. The 3D printer filament composition of claim 1, wherein
the plasticizer includes paraffin wax, carnauba wax, microcrystalline wax, beeswax, montan wax, fatty acid wax, natural wax, or a mixture thereof.

6. The 3D printer filament composition of claim 1, wherein
the lubricant includes stearic acid, Zn-stearate, Ca-stearate, ethylene bis steramide (EBS), or a mixture thereof.

7. A 3D printer filament manufactured by extruding the 3D printer filament composition containing a metal powder of claim 1.

8. The 3D printer filament of claim 7, wherein the 3D printer filament has a diameter of 1.5 to 3.0 mm.

9. A method of manufacturing a metal steel product, comprising
melting the 3D printer filament of claim 7 to form a semi-finished product in which print layers are continuously laminated in a three-dimensional shape of an object to be printed,
degreasing for 6 hours to 10 hours at 110° C. to 120° C. and under conditions of 98% or more nitric acid in order to remove the polymeric binder component from the semi-finished product,
sintering at a high temperature of 1350° C. to 1380° C. to prepare a metal sintered body, and
cooling the metal sintered body to room temperature.
